(19) United States
(12) Patent Application Publication
(10) Pub. No.: US 2020/0349572 A1
(43) Pub. Date: Nov. 5, 2020

(54) SYSTEMS AND METHODS FOR MONITORING MESSAGE CONTENT OVER A COMPUTER NETWORK

(71) Applicant: MASTERCARD INTERNATIONAL INCORPORATED, Purchase, NY (US)

(72) Inventors: Daniel Brian O'Sullivan, White Plains, NY (US); Theodore Michael Black, JR., Northport, NY (US)

(21) Appl. No.: 16/864,424

(22) Filed: May 1, 2020

Related U.S. Application Data
(60) Provisional application No. 62/843,031, filed on May 3, 2019.

(51) Int. Cl. G06Q 20/40

(52) U.S. Cl. CPC G06Q 20/407; G06Q 20/4015; G06Q 20/4014

(57) ABSTRACT

Provided herein is a method for monitoring message content processed over a payment processor for a cardholder using a rules engine computing device. The rules engine computing device is associated with the payment processor that maintains a transaction history database that includes records for a plurality of payment transactions, and each of the records including a payment account number (PAN), a merchant identifier, and a transaction amount. The method includes (i) receiving a message from a registration computing device indicating that the cardholder is enrolled in a transaction monitoring service; (ii) associating the at least one PAN with the transaction monitoring service; (iii) querying the transaction history database to retrieve records including the at least one PAN; (iv) identifying a subset of transactions from the retrieved records; and (v) transmitting a list of the identified subset of transactions to at least one of the cardholder and the registration computing device.

### CROSS-REFERENCE TO RELATED APPLICATIONS

This application claims priority to U.S. Provisional Patent Application Ser. No. 62/843,031, filed May 3, 2019, entitled “SYSTEMS AND METHODS FOR MONITORING TRANSACTIONS FOR REFUNDING CONDITIONAL CONSUMPTION TAXES”, the disclosure of which is incorporated herein by reference in its entirety.

### BACKGROUND OF THE DISCLOSURE

The field of the disclosure relates generally to monitoring messages transmitted over a computer network, and, more specifically, to network-based systems and methods for monitoring messages transmitted over a computer network for content indicating user acquisition and non-consumption.

Messages transmitted over a computer network (e.g., a payment processor) may include transaction data associated with transactions processed over the computer network. For example, the messages may include timestamps of the transactions, transaction amounts, merchant identifiers of merchants where the transactions are initiated, and other information associated with the transactions.

Conditional consumption taxes (e.g., value-added taxes, also referred to as VAT, and goods and services taxes, also referred to as GST) are taxes added by certain jurisdictions or countries, and the conditional consumption taxes are paid by consumers. Conditional consumption taxes are typically only necessarily paid by residents of the jurisdictions (e.g., the European Union) or countries that charge the conditional consumption taxes, and tourists usually are not required to pay the conditional consumption taxes on all purchases. That is, tourists are entitled to a refund of certain conditional consumption taxes they paid once they leave the country or jurisdiction with the goods. For example, a tourist from the United States visiting France would be entitled to a refund of the conditional consumption taxes they paid on refund-eligible purchases when they leave France.

The current system of claiming conditional consumption tax refunds is arduous and time-consuming. Typically, tourists have to determine which purchases are eligible for the refund, specifically request conditional consumption tax refund forms from each merchant they visit, fill out the individual forms from the merchant, keep the forms for the entirety of their trip, and then go to customs before they leave the country to get the forms cleared and stamped. Customs sends the stamped forms back to the merchants, and the merchants subsequently process the refund. Some merchants use third party refund managers or agents, and the refunds can take months to receive.

Accordingly, it is desired to have a system that will automatically monitor messages transmitted over a computer network, such as a payment processing network, for conditional consumption tax refund-eligible transaction messages associated with cardholders, and transmit information about the refund-eligible transactions to cardholders so that the cardholders can easily submit the forms to customs agents or directly to third-parties responsible for providing said refunds.

### BRIEF DESCRIPTION OF THE DISCLOSURE

In one aspect, a method for message content processed over a payment processor for a cardholder using a rules engine computing device is provided. The rules engine computing device is associated with the payment processor that maintains a transaction history database, and the transaction history database including records for a plurality of payment transactions. Each of the records includes a payment account number (PAN), a merchant identifier, and a transaction amount. The method includes: (i) receiving a message from a registration computing device indicating that the cardholder is enrolled in a transaction monitoring service, the message including information identifying at least one PAN of the cardholder, (ii) associating the at least one PAN with the transaction monitoring service, (iii) querying the transaction history database to retrieve records including the at least one PAN, (iv) identifying, based on the rules, a subset of transactions from the retrieved records, wherein the subset of transactions are the payment transactions that are at least partially refund-eligible, and (v) transmitting a list of the identified subset of transactions to at least one of the cardholder and the registration computing device.

In another aspect, a rules engine computing device for monitoring message content processed over a payment processor for a cardholder is provided. The rules engine computing device is associated with the payment processor that maintains a transaction history database, and the transaction history database includes records for a plurality of payment transactions. Each of the records includes a payment account number (PAN), a merchant identifier, and a transaction amount, and the Rules engine computing device includes one or more processors in communication with one or more memory devices. The rules engine computing device is configured to: (i) receive a message from a registration computing device indicating that the cardholder is enrolled in a transaction monitoring service, the message including information identifying at least one PAN of the cardholder, (ii) associate the at least one PAN with the transaction monitoring service, (iii) query the transaction history database to retrieve records including the at least one PAN, (iv) identify, based on the rules, a subset of transactions from the retrieved records, wherein the subset of transactions are the payment transactions that are at least partially refund-eligible, and (v) transmit a list of the identified subset of transactions to at least one of the cardholder and the registration computing device.

In yet another aspect, at least one non-transitory computer-readable media having computer-executable instructions thereon for monitoring transactions for monitoring message content processed over a payment processor for a cardholder using a rules engine computing device is provided. The rules engine computing device is associated with the payment processor that maintains a transaction history database, and the transaction history database includes records for a plurality of payment transactions. Each of the records including a payment account number (PAN), a merchant identifier, and a transaction amount. When executed by at least one processor of the rules engine computing device, the computer-executable instructions cause the at least one processor to: (i) receive a message from a registration computing device indicating that the cardholder is enrolled in a transaction monitoring service, the message including information identifying at least one PAN of the cardholder, (ii) associate the at least one PAN with the transaction monitoring service, (iii) query the transaction history database to retrieve records including the at least one PAN, (iv) identify, based on the rules, a subset of transactions from the retrieved records, wherein the subset of transactions are the payment transactions that are at least partially refund-eligible, and (v) transmit a list of the identified subset of transactions to at least one of the cardholder and the registration computing device.

### BRIEF DESCRIPTION OF THE DRAWINGS

FIGS. 1-7 show example embodiments of the methods and systems described herein.

FIG. 1 is a schematic diagram illustrating an example multi-party payment account system for enabling payment transactions with a rules engine computing device for monitoring message content associated with the payment transactions processed over the multi-party payment account system in accordance with one embodiment of the present disclosure.

FIG. 2 is an expanded block diagram of an example embodiment of a rules engine platform including the rules engine computing device shown in FIG. 1.

FIG. 3 illustrates an example configuration of a server system such as the rules engine computing device shown in FIGS. 1 and 2.

FIG. 4 illustrates an example configuration of a client system shown in FIG. 2.

FIG. 5 is a data flow diagram showing an example flow of data within the rules engine platform of FIG. 2.

FIG. 6 is a simplified diagram of an example method for monitoring message content using the rules engine computing device of FIG. 2.

FIG. 7 is a diagram of components of one or more example computing devices that may be used in the environment shown in FIG. 2.

### DETAILED DESCRIPTION OF THE DISCLOSURE

The systems and methods described herein include a rules engine computing device that is configured to monitor message content (e.g., messages including transaction data) over a computer network (e.g., a payment processor). For example, the rules engine computing device may monitor transaction data included in messages for transactions associated with conditional consumption taxes of a consumer, who is a payment account holder (e.g., a cardholder) enrolled in a transaction monitoring service through an issuer of their payment account (e.g., a payment card), or through a third party refund agent. That is, the rules engine computing device is configured to monitor a specific subset of transactions of the consumer, and the specific subset of transactions are transactions associated with conditional consumption taxes. The rules engine computing device includes a processor in communication with a memory. The rules engine computing device is in communication with a payment processing network associated with a payment processor and is also in separate communication with the issuer. In the example embodiment, the cardholder initiates one or more payment transactions (e.g., by presenting the payment card) at a point of sale. Transaction data (e.g., message content) resulting from the one or more transactions is transmitted to the rules engine computing device, and the rules engine computing device receives the transaction data. The rules engine computing device is configured to analyze the transaction data over a specific date range (e.g., travel dates for the cardholder) and identify whether the transactions are conditional consumption tax refund-eligible (e.g., acquired by the cardholder and not consumed by the cardholder over the specific date range and/or in the specific geographical area). Once the refund-eligible transactions are identified, the rules engine computing device transmits a list of all of the identified refund-eligible transactions to the cardholder for the specific date range.

Consumers/cardholders/accountholders (e.g., an entity using a payment card such as a credit card, debit card, or a prepaid card) initiate payment transactions to pay for purchases from merchants. Signals including transaction data associated with these payment transactions are received and processed over the payment processing network. The transaction data may include data identifying the cardholder (e.g., a billing address of the cardholder), data identifying the merchant (e.g., a merchant identifier and/or a location of the merchant), a PAN associated with the transaction, a timestamp associated with the transaction, a transaction amount, and/or other data.

In the example embodiment, the rules engine computing device is configured to receive a plurality of signals including a plurality of transaction data from the payment processing processor. For example, the payment processing network may be a processing network configured to process payment card transactions initiated by cardholders of payment cards. The rules engine computing device identifies a candidate signal from the plurality of signals as corresponding to a transaction initiated by the payment cardholder, wherein the candidate signal identified is based on a PAN included in the transaction data of the candidate signal. The transaction data of the candidate signal includes a merchant identifier corresponding to the merchant associated with the payment transaction. The rules engine computing device retrieves, from the transaction data of the candidate signal, at least the PAN, the merchant identifier, and the transaction amount, and may also receive merchant category codes (MCCs) and information about items purchased in the transaction.

Based on the received transaction data, the rules engine computing device identifies refund-eligible transactions initiated by the cardholder using a payment card. The rules engine computing device determines whether transactions are refund-eligible based on a plurality of different rules associated with the cardholders, the locations of purchases, the products purchased, etc., as described below. The refund-eligible transactions are stored in a database associated with the cardholder and are tracked over the specific date range. The specific date range may be input by the user and/or may be determined by the rules engine computing device, as described below. Once the specific date range nears an end, the rules engine computing device transmits a list of the stored refund-eligible transactions to the cardholder. The list can be provided to an application running on a client device (the cardholder's laptop, tablet, smart phone, wearable device, etc.) and/or may be provided to certain third parties (e.g., a country's customs agency) such that the conditional consumption tax refund may be approved electronically. In some embodiments, the list is implemented as, or accompanied by, a consumption tax refund form that may be directly submitted to the third parties that approve the refund.

The rules engine computing device is configured to identify products purchased in the refund-eligible transactions. In some embodiments, the rules engine computing device may identify the products purchased based on the received merchant identifier or merchant category code (e.g., if the merchant is a grocery store, the rules engine computing device may identify that the products purchased were food items). Further, the rules engine computing device may identify the products purchased by predicting the products based on historical transaction data associated with the cardholder. For example, if the rules engine computing device determines that the merchant identifier or merchant category code is for a department store, the rules engine computing device may not be able to immediately determine what products the cardholder purchased since department stores sell a variety of products (e.g., clothing, jewelry, perfume/cologne, cosmetics, housewares, etc.). Accordingly, the rules engine computing device may retrieve historical transaction data for the cardholder to predict which products the cardholder bought (e.g., if the cardholder usually buys clothing at department stores, the rules engine computing device will predict that the cardholder bought clothing). Additionally or alternatively, the rules engine computing device may use the transaction amount to predict the purchased item(s).

In other embodiments, the rules engine computing device may receive a list of products purchased by a cardholder from a merchant. The merchant may be partnered with a third party (e.g., a third party refund agent or any third parties providing consumption transaction monitoring services) and provide the third party with product-specific data associated with the products purchased by the cardholder at the merchant. Accordingly, the third party transmits the list of products and/or product-specific data associated with products purchased by the cardholder to the rules engine computing device.

In these embodiments, the rules engine computing device is configured to receive a plurality of signals including a plurality of product data (e.g., product-specific data) from the third party. Accordingly, the rules engine computing device can match the signals associated with the product data and the signals associated with the transaction where the cardholder bought the products based on matching data between the two signals (e.g., matching PANs, matching user identifiers, etc.). That is, the rules engine computing device matches the transaction data and the product data such that the transaction data includes supplemental data associated with the transaction. For example, the supplemental data includes the merchant at which the cardholder initiated the transaction, the products purchased during the transaction, the price of the products purchased during the transaction, product categories or descriptions, etc.

The rules engine computing device may then prompt the cardholder, through the application, to verify that the identified and/or predicted products were purchased and provide an opportunity to update. The verified products are stored and subsequently included in the lists provided to the cardholder.

In the example embodiment, the rules engine computing device is further configured to monitor transaction data for a plurality of cardholders and determine, for the issuer and/or the third party refund agent, candidate cardholders for the transaction monitoring service. That is, if the transaction data of monitored cardholders satisfies more rules determining whether transactions are refund-eligible, the rules engine computing device generates a list of the candidate cardholders and transmits the list to the respective issuers or refund agents, who may then offer the transaction monitoring service to the candidate cardholder.

In some embodiments, the rules engine computing device is configured to transmit notifications to the cardholders. For example, the notifications may include enrollment information for the transaction monitoring service, targeted advertising, reminders to submit customs forms for refunds, alerts for potential refund-eligible transactions, etc. As described above, the third party refund agent may have partnerships with merchants, wherein the merchants provide product data (e.g., SKU data) to the third party refund agent. This product data allows the third party refund agent to easily determine products purchased and the prices of the products purchased in transactions initiated with the merchants. The third party refund agent transmits the product data to the rules engine computing device and allows the rules engine computing device to quickly and efficiently identify refund-eligible transactions (e.g., without having to predict which products were purchased at the merchants). Accordingly, the rules engine computing device may transmit targeted advertising to the cardholders to promote the partnered merchant. For example, the rules engine computing device may transmit coupons, discount codes, and other promotional material to the cardholders to promote the partnered merchants.

As explained in greater detail below, the rules engine computing device monitors transaction signals and/or transaction data associated with a plurality of cardholders associated with respective issuers in the Monitoring Phase. The issuers, or third-party refund agents, enroll the cardholders in a transaction monitoring service supported by the rules engine computing device, and enrollment information is received by the rules engine computing device in the Enrollment Phase. In the Data Acquisition Phase, transaction data received from a payment processor and/or a third party is associated, by the rules engine computing device, with an enrolled cardholder and the specific date range is determined. The rules engine computing device identifies refund-eligible transactions associated with the cardholder over a specific date range in the Identification Phase. The identified refund-eligible transactions are stored and tracked for the specific date range in the Tracking Phase. In the Transmission Phase, a list of the stored and tracked refund-eligible transactions is transmitted to the cardholder and/or to the refund agent at a suitable time before the cardholder is scheduled to leave the conditional-consumption-tax jurisdiction, such as within 48 hours prior to the last date of the specific date range.

### Conditional Consumption Tax Rules

Conditional consumption taxes are charged by certain countries and/or jurisdictions (e.g., the European Union, also referred to as the EU) and are paid for by consumers. Conditional consumption taxes vary from jurisdiction-to-jurisdiction and from country-to-country (e.g., France and Germany) even within a jurisdiction, and there are many rules for conditional consumption taxes. The rules are related to, for example, purchase location, aggregate or per-purchase transaction amounts, purchased item categories, residences of purchasers, etc. In most countries and jurisdictions, if a purchase is acquired, but not consumed, in the country or jurisdiction, it may be eligible for a refund of the conditional consumption taxes. For example, if a tourist from the United States vacations in France and buys jewelry, perfume, and wine as souvenirs to take back to the United States, the tourist may be entitled to a refund for the conditional consumption taxes paid on those items if the total cost of the items is above a certain threshold (e.g., €175.01). However, that tourist would not be entitled to a refund of the conditional consumption taxes charged on a hotel or meal purchase because those items are “consumed” in France. Further, a German resident who visits France and buys souvenirs to take back to Germany would not be eligible for a conditional consumption tax refund because Germany and France are both members of the EU, and residents of the EU are not eligible for conditional consumption tax refunds from countries within the EU. In the example embodiment, the rules engine computing device compiles and stores the many rules associated with conditional consumption taxes in a memory associated with the rules engine computing device. The rules engine computing device utilizes the stored rules in the Monitoring, Data Acquisition, Identification, and Tracking Phases.

### Monitoring Phase

In the example embodiment, the rules engine computing device monitors and receives message content (e.g., transaction data) associated with payment cards of a plurality of cardholders from a payment processing network. The rules engine computing device monitors the received transaction data to determine candidate cardholders for a transaction monitoring service associated with respective issuers of the payment cards or with third-party refund agents. The rules engine computing device determines candidate cardholders based on whether the transactions associated with the cardholder may be eligible for conditional consumption tax refunds. For example, the rules engine computing device monitors the transactions of cardholders whose home countries (i.e., residences of the cardholder) are outside of the countries and/or jurisdictions in which the cardholder has made a purchase and which countries and/or jurisdictions charge conditional consumption taxes. The rules engine computing device then determines if the monitored cardholders make transactions that suggest travel to, or presence in, countries and/or jurisdictions that apply conditional consumption taxes for which the cardholder, having a home country outside of that country and/or jurisdiction, may be eligible for a refund of such tax. For example, the rules engine computing device may flag a cardholder as a candidate cardholder if the cardholder purchases plane tickets to a country and/or jurisdiction that charges conditional consumption taxes for which the cardholder may be eligible for a refund (e.g., the rules engine computing device may determine that a resident of America who books travel to Germany is a candidate cardholder, but would not so identify a cardholder resident in France, an EU country, booking travel to Germany, another EU country). Further, the rules engine computing device may flag a cardholder as a candidate cardholder if the cardholder makes a purchase in a country and/or jurisdiction that charges conditional consumption taxes (e.g., the rules engine computing device may determine that a resident of America who makes a purchase in Paris is a candidate cardholder). In some embodiments, the rules engine computing device may distinguish, to the extent relevant for the conditional consumption tax rules, between purchases made in-person and those made remotely (e.g., e-commerce purchases). The rules engine computing device then generates and stores a list of candidate cardholders. The list of monitored cardholders that are determined to be candidate cardholders may be transmitted to respective issuers at predetermined intervals.

### Enrollment Phase

In the example embodiment, the rules engine computing device is configured to transmit the list of candidate cardholders to respective issuers of the payment accounts and/or payment cards associated with the candidate cardholders, or alternatively, to a third-party refund agent (e.g., if the issuer does not offer a tax tracking application). Once the issuer or refund agent receives the list of candidate cardholders, the issuer or refund agent may prompt the candidate cardholders with an opportunity to enroll in the transaction monitoring service. Specifically, candidate cardholders may be directed to a webpage (via a link) to download a page for a tax tracking application associated with the transaction monitoring service or to a tax-tracking module within a general issuer application already installed on the cardholder's user device, and prompt the candidate cardholders to enter their enrollment information. Enrollment information input by the candidate cardholders may include proof of residency (e.g., their passport, driver's license, and/or state ID numbers) and other personal information (e.g., address, phone number, etc.). In some embodiments, if the candidate cardholders know that they will be going to countries and/or jurisdictions that charge conditional consumption taxes, the candidate cardholders may also be able to input their travel dates into the website and/or application.

In some embodiments, enrollment in the transaction monitoring service may further include linking or registering additional payment account numbers (PANs) associated with the cardholder. For example, a cardholder may enroll in the transaction monitoring service with a corporate payment card that the cardholder used to book international travel, but the cardholder may also want to also include the cardholder's personal payment card(s) in the transaction monitoring service. For further example, a cardholder may enroll in the transaction monitoring service for one of the cardholder's payment cards issued by an issuer, and the cardholder may also want to include additional payment cards issued by one or more separate issuers in the transaction monitoring service. The rules engine computing device may then consolidate all purchases made on any enrolled PANs associated with the cardholder for the transaction monitoring service.

In some embodiments, the rules engine computing device may store, in a database, a unique identifier that links the cardholder payment account number (PAN) with the issuer, a refund application, or a third-party refund agent. For example, the cardholder may have previously enrolled with the issuer or refund agent to obtain consumption tax refunds on a prior international trip. The rules engine computing device may use the unique identifier to notify the issuer or refund agent that the cardholder is already enrolled and provide cardholder information required for the transaction monitoring service.

After the candidate cardholders are enrolled, their enrollment information is stored by the issuer or refund agent, and the enrollment information of the candidate cardholders is linked to the payment account numbers (PANs) associated with the candidate cardholders. The issuer or refund agent then transmits a message to the rules engine computing device that the candidate cardholders are enrolled in the transaction monitoring service, and the message includes the PANs of the respective candidate cardholders. The issuer or refund agent may also transmit the travel date range, if entered by the cardholder.

### Data Acquisition Phase

In the example embodiment, the rules engine computing device is configured to receive the message from the issuer or third-party refund agent. The rules engine computing device is configured to then associate the PAN included in the received message with the transaction monitoring service. Accordingly, the rules engine computing device tracks the transactions and transaction data associated with the PAN. That is, the rules engine computing device determines if a transaction signal of a plurality of received transaction signals includes a PAN associated with the transaction monitoring service. For example, the rules engine computing device maintains a database of PANs for cardholders participating in the transaction monitoring service and queries the database for PANs in received transaction signals. Upon identifying a match, the corresponding transaction signal is identified as a candidate signal, and the candidate signal is determined to correspond to a purchase made by a cardholder enrolled in the transaction monitoring service and for whom the rules engine computing device is tracking transactions and taxes associated with those transactions.

Upon identifying a candidate signal corresponding to a purchase made by a cardholder for whom the rules engine computing device is monitoring transactions and taxes associated with those transactions (e.g., an enrolled cardholder), the rules engine computing device determines whether to select the candidate signal as associated with a refund-eligible transaction. The rules engine computing device selects a candidate signal if the candidate signal further corresponds with the stored rules described above. For example, the rules engine computing device retrieves merchant information (e.g., a merchant identifier, a merchant category code, and a merchant location) included in or derivable from the transaction data of the candidate signal. The rules engine computing device compares the retrieved merchant location to the rules associated with the merchant location. Based on the comparison, the rules engine computing device determines if the candidate signal corresponds with a transaction associated with the stored rules. For example, the merchant location may indicate that the merchant is located in a country and/or jurisdiction that charges conditional consumption taxes. If the rules engine computing device determines that the candidate signal corresponds with a merchant located in one of these countries and/or jurisdictions, the candidate signal is selected. Further, if the cardholder has identified (e.g., via an application associated with the rules engine computing device) that they will be traveling to a country and/or jurisdiction that charges conditional consumption taxes and the cardholder identifies a specific date range that they will be traveling, the rules engine computing device may select all candidate signals within the specific date range.

### Identification Phase

Upon selecting signals, the rules engine computing device retrieves from the transaction data of the selected signal a transaction amount, merchant identifiers (e.g., a merchant location and a merchant category code), and a PAN. The rules engine computing device uses the merchant identifiers and/or merchant category codes to retrieve information about the products offered by the merchant. The products available for purchase may be retrieved from a database maintained by the rules engine computing device. For example, the rules engine computing device may maintain product information for a plurality of merchants. In alternative embodiments, the rules engine computing device uses the merchant identifiers to query a remote database. For example, the rules engine computing device may use an Internet connection to query a database or website maintained by the merchant to retrieve information about products available for sale. Using the merchant identifiers and the transaction amount, the rules engine computing device identifies and/or predicts product(s) purchased in a present transaction. For example, if the received merchant identifier shows that the merchant generally sells items in a single category as defined by the applicable conditional consumption tax (e.g., TIFFANY & CO. primarily sells jewelry and the category “jewelry” is sufficiently specific to identify the type of goods for the conditional consumption tax refund in the country and/or jurisdiction of the TIFFANY & CO. merchant location in the transaction database), the Rules engine computing device will conditionally identify the types of goods sold as jewelry. If, for example, the received merchant identifier shows that the merchant is a restaurant, the rules engine computing device identifies that the products purchased at the merchant are food items. However, if the received merchant identifier shows that the merchant is a department store that sells many different products, the rules engine computing device may have to predict what products were purchased in the transaction.

In alternate embodiments, instead of and/or in addition to identifying products based upon the transaction data, the rules engine computing device receives signals associated with product data in addition to the signals associated with transactions. The signals associated with product data may be received from a merchant and/or a third party (e.g., third party refund agent). The signals associated with the product data identify specific products (e.g., through SKU data) and/or product categories that each cardholder purchased for each transaction. Accordingly, the rules engine computing device matches the signals associated with the product data and the signals associated with the transaction associated with the acquisition of the products based on matching data between the two signals (e.g., matching PANs, matching cardholder identifiers, etc.).

In predicting and/or receiving products purchased at the merchant, the rules engine computing device may retrieve historical transaction data associated with the cardholder and/or merchant involved in the transaction relating to the current merchant identifier. That is, the rules engine computing device may query a database to retrieve historical transaction data associated with the cardholder including a merchant identifier similar to the received merchant identifier of the present transaction. The rules engine computing device is configured to analyze the retrieved historical transaction data to predict what products the cardholder purchased in the present transaction. For example, if the rules engine computing device analyzes the retrieved historical transaction data and identifies that the cardholder typically only buys clothing items at department stores and the merchant is identified as a department store, the rules engine computing device may predict that the cardholder purchased clothing in the present transaction. Further, if the rules engine computing device analyzes the retrieved historical transaction data and identifies that the cardholder typically only buys houseware products at a certain department store and the department store is not involved in the present transaction, the rules engine computing device may predict that the cardholder purchased clothing, jewelry, and/or cosmetics in the present transaction. In some embodiments, the rules engine computing device is configured to predict the product based on a level of specificity based on the rules according to the country and/or jurisdiction where the product was bought.

In alternative embodiments, the transaction data includes stock keeping unit (“SKU”) data which identifies the products purchased by the cardholder in the present transaction. Using the SKU data, the rules engine computing device identifies the products purchased by the cardholder.

Upon identifying and/or predicting the products purchased from the merchant in the present transaction, the rules engine computing device transmits a prompt to a user client device. For example, the rules engine computing device transmits an instruction which causes an application on the user client device to display the prompt. The instruction may be in the form of a link embedded in email, SMS message, or push notification, or may directly activate the application. The prompt identifies the identified and/or predicted purchased products and prompts the cardholder to confirm that the identified and/or predicted purchased products are correct or input that the products are incorrect, and the rules engine computing device may provide alternative products to the identified and/or predicted purchased products. If the identified and/or predicted purchases are confirmed to be correct by the user (e.g., the cardholder), the rules engine computing device identifies that the identified and/or predicted products are correct. If the identified and/or predicted purchased products are not correct, the user may correct the identified and/or predicted purchased products through the user application and/or provide the rules engine computing device with more information about the products so that the rules engine computing device may more accurately identify and/or correct the purchased products. In some embodiments, the user may input the products they purchased directly into the user application. In alternative embodiments, the user may take a picture of the receipt and/or the actual products purchased for the user application/the rules engine computing device to analyze and identify the actual products purchased. Once the identified and/or predicted products purchased are either confirmed to be correct or corrected by the user, the products are identified by the rules engine computing device as the selected products purchased. In some embodiments, the user may also notify the rules engine computing device that the identified and/or predicted products purchased, either in-whole or in-part, were not eligible for the conditional consumption tax refund. For example, the cardholder may notify the rules engine computing device that an identified and/or predicted product is a gift for a local resident and will not be taken out of the country and/or jurisdiction where the product was purchased.

Using the retrieved and identified product information, the rules engine computing device determines if the present transaction is potentially refund-eligible. That is, the rules engine computing device uses the stored rules relating to conditional consumption taxes to determine if the transactions are potentially eligible for a refund of the conditional consumption taxes. For example, if the rules engine computing device determines that the products purchased in the present transaction are jewelry and cosmetics (e.g., non-consumable goods) purchased from a department store, the rules engine computing device identifies that the present transaction may be refund-eligible. If the rules engine computing device determines that the products purchased in the present transaction are a meal at a restaurant or a night's stay at a hotel, the rules engine computing device determines that the present transaction is not refund-eligible.

### Tracking Phase

The received potentially refund-eligible transactions for the specific date range are stored in a database by the rules engine computing device in one or more entries corresponding to the cardholder. In some embodiments, all of the refund-eligible transactions for the specific date range are stored as a single record. In other embodiments, the refund-eligible transactions are broken down into multiple records by date, transaction, and/or products purchased. In some embodiments, the rules engine computing device may further retrieve refund-eligible transactions for the specific date range from another data source and aggregate the retrieved refund-eligible transactions with the already stored transactions in the database. For example, the rules engine computing device may retrieve refund-eligible transactions from a database associated with an issuer of another payment card associated with the cardholder. The rules engine computing device may store additional information with the refund-eligible transactions. For example, the rules engine computing device may track spending habits for the cardholder over the specific date range (e.g., while the cardholder is traveling) and/or may track spending trends for the products purchased over the specific date range.

Most countries and/or jurisdictions that charge conditional consumption taxes require a minimum amount be spent (either per transaction, per merchant, or in the aggregate per trip) on refund-eligible transactions before the refunds are actually refunded. Accordingly, the rules engine computing device tracks the amount spent on the refund-eligible transactions over the specific date range. If the rules engine computing device determines that the total amount spent on refund-eligible purchases is above the threshold for the respective country and/or jurisdiction (e.g., based on the stored rules for that country and/or jurisdiction), the rules engine computing device determines that the cardholder is eligible for the refund of the conditional consumption taxes for the refund-eligible transactions. If the rules engine computing device determines that that total amount spend on refund-eligible purchases is not above the threshold for the respective country and/or jurisdiction, the rules engine computing device determines that the cardholder is not eligible for the refund absent additional information that the rules engine computing device may be unaware of (e.g., qualifying purchases made with cash).

### Transmission Phase

The tracked refund-eligible transactions and the determination of the rules engine computing device of whether the cardholder is eligible for a refund of conditional consumption taxes for refund-eligible transactions are communicated to a cardholder by the rules engine computing device. For example, the rules engine computing device communicates with the cardholder directly through the application on the user client device. In some examples, the rules engine computing device may communicate through the issuer, and the issuer may forward the communication to the application on the user device. After the rules engine computing device determines that the specific date range is coming to an end or has ended, the rules engine computing device transmits the necessary information about the refund-eligible purchases to the cardholder such that they may start the process of getting a refund of the conditional consumption taxes. For example, the rules engine computing device may remind the cardholder to locate and ensure the completion of any refund forms previously provided by merchants. For another example, the rules engine computing device may generate one or more consumption tax refund forms including all of the identified refund-eligible transaction for the respective country and/or jurisdiction. The generated forms may be printed out by the cardholder to submit to a customs agency of the respective country and/or jurisdiction. Further, the rules engine computing device may be configured to communicate with the customs agency of the respective country and/or jurisdiction such that the forms, after being reviewed by the cardholder, may be electronically submitted to the respective customs agency. In these embodiments, the rules engine computing device may further be configured to provide the refund to the cardholder on behalf of the customs agency. For example, the rules engine computing device may provide the cardholder with a prepaid card including the refund amount. Additionally or alternatively, the rules engine computing device may be configured to provide the refund in any other suitable format including statement credits, checks, cash, digital wallet credits, etc.

The rules engine computing device is further configured to provide notifications to the cardholders through the application on the user client device. For example, the rules engine computing device may notify the cardholder in real-time or near-real-time (e.g., through a push notification and/or SMS message) that a present transaction may be refund-eligible. The rules engine computing device may also notify the cardholder about the threshold for receiving the conditional consumption tax refund and may update the cardholder on how close the cardholder is to the threshold. For example, if the cardholder is in France the notification may include that the threshold for France is €175.01 and that the cardholder has spent €100.00 on refund-eligible transactions. The rules engine computing device may also notify the cardholder at the end of the specific date range that they did not meet the threshold requirement and are therefore not eligible for the conditional consumption tax refund.

Further, the rules engine computing device may notify the cardholder and/or refund agent that the specific date range is coming to an end and remind the cardholder to submit the merchant-provided and/or rules engine computing device-generated consumption tax refund forms before the cardholder leaves the respective country and/or jurisdiction. This notification may be sent to the cardholder and/or refund agent within a suitable interval prior to the cardholder's departure from the jurisdiction, such as within 48 hours of the end of the specific date range. Further, the rules engine computing device may use stored rules associated with the conditional consumption tax refunds (e.g., conversion rates, service fees, administrative fees, etc.) to calculate an exact amount that the cardholder will receive for the refund. In some embodiments, the rules engine computing device calculates the consumption tax refund amount itself (e.g., based upon the conditional consumption tax rules and the transactions of the cardholder). In other embodiments, the rules engine computing device may receive the calculated conditional consumption tax refund amount from a third party (e.g., third party refund agent). For example, the rules engine may subtract money lost due to conversion rates, service fees, administrative fees, etc. from the estimated refund to calculate an exact refund amount that the cardholder should receive. Accordingly, the rules engine computing device may provide a notification for the cardholder including the exact amount that the cardholder will receive for the refund.

As described above, in some embodiments, the rules engine computing device receives product data from a third party (e.g., third party refund agent). In these embodiments, the third party may require that the cardholder enter an identifier with each initiated transaction at each merchant. By requiring the cardholder to enter the identifier, the third party can easily identify which transactions at which merchants belong to which cardholders. Accordingly, since the rules engine computing device may receive transaction data in real-time or near-real-time, the rules engine computing device may also provide notifications to the cardholder associated with the identifier. For example, if the rules engine computing device receives transaction data from the merchant that does not include the identifier, the rules engine computing device may transmit a notification to the cardholder that the cardholder needs to enter the identifier (e.g., when the cardholder is still close to the merchant). Further, the rules engine computing device may flag the transaction as requiring additional analysis to determine if the transaction is potentially refund-eligible.

In some embodiments, the rules engine computing device outputs refund-eligible transactions, notifications, and/or analytics to an application associated with the rules engine computing device running on a user client system or to a web server associated with the rules engine computing device. In alternative embodiments, the rules engine computing device outputs the refund-eligible transaction, notifications, and/or analytics to an issuer-supported application, a third party application, user client system, or service. The rules engine computing device may further receive additional cardholder information from third party applications or user client systems of the cardholder. For example, the rules engine computing device may receive proof of residency for the cardholder (e.g., the cardholder's passport number) from the issuer. In these instances, the proof of residency information allows the rules engine computing device to more completely generate the consumption tax refund forms for the cardholder.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The technical effects of the systems and methods described herein include at least one of (a) determining candidate cardholders for a transaction monitoring service; (b) automatically determining specific dates that a cardholder will be traveling to countries and/or jurisdictions that charge conditional consumption taxes; (c) automatically tracking refund-eligible transactions for products purchased by a cardholder; (d) identifying a signal corresponding to a purchase made by a cardholder for whom the refund-eligible transactions are being tracked; (e) identifying transactions corresponding to a purchase made at a merchant in a country and/or jurisdiction that charges conditional consumption taxes; (f) applying rules to determine that the transaction corresponds to refund-eligible transactions based on the products purchased; (g) generating, based on stored refund-eligible transactions associated with the cardholder, consumption tax refund forms; (h) fully automating the receipt of conditional consumption tax refunds such that cardholders do not have to physically interact with customs officials; and (i) providing a central location to store all data (e.g., historical transaction data, conditional consumption tax rules, etc.) relating to refund-eligible transactions.

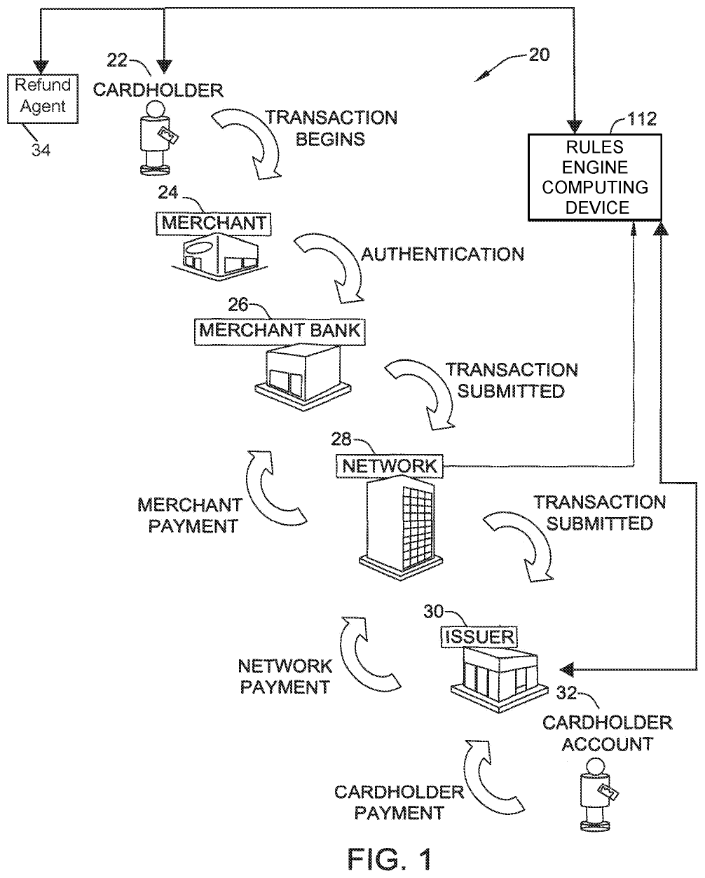

FIG. 1 is a schematic diagram illustrating an example multi-party payment card system 20 for enabling payment-by-card transactions along with a rules engine computing device for monitoring message content (e.g., transactions and transaction data) for a cardholder. FIG. 1 depicts a flow of data in an example financial transaction through system 20, and also includes monitoring by the rules engine computing device 112. Components of system 20 provide rules engine computing device 112 with transaction data, which rules engine computing device 112 processes to automatically track refund-eligible transactions purchased by a cardholder/consumer, and provide the data on a user interface.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are customers of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. The “issuer” as referred to herein relates to any issuer of a transaction card and/or any third party product or service that acts on behalf the issuer. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

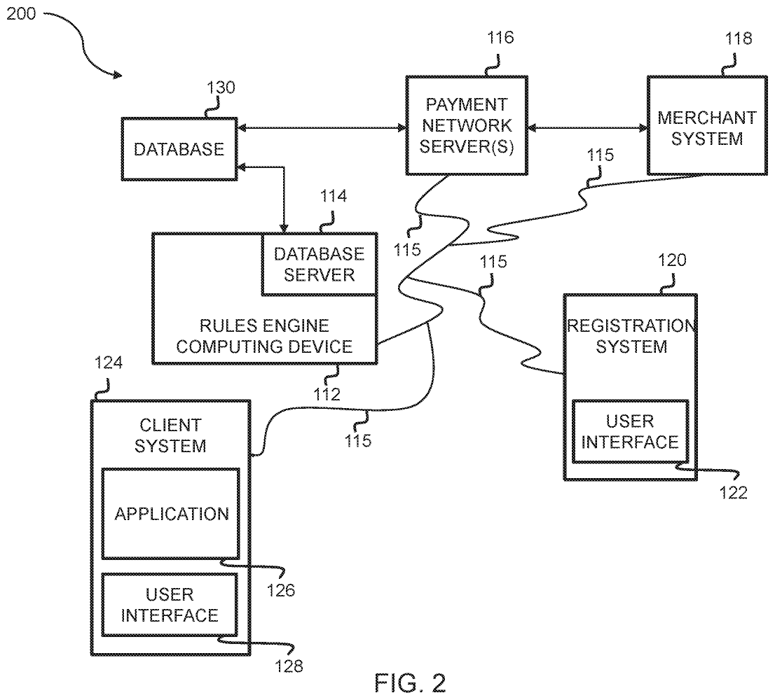

When a request for authorization is accepted, the available credit line of cardholder's 22 account 32 is decreased. Normally, a charge for a payment card transaction is not posted immediately to cardholder's 22 account 32 because bankcard networks, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information and/or transaction information such as a type of merchant, amount of purchase, date of purchase, and/or other information in a database 130 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including rules engine computing device 112. In the example embodiment, interchange network 28 provides such transaction data and additional transaction data to rules engine computing device 112. In alternative embodiments, any party may provide such data to rules engine computing device 112.

In the example embodiment, rules engine computing device 112 further communicates with issuer 30 or a refund agent 34, and/or with a user computing device of cardholder 22, via a communication channel separate from interchange network 28, such as, but not limited to, the Internet and/or cellular data link.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

In one embodiment, rules engine computing device 112 is part of interchange network 28. Rules engine computing device 112 may, for example, receive and process signals, including transaction data sent between other parties of interchange network 28 such as issuer banks 30 and merchant banks 26. In another embodiment, rules engine computing device 112 is a separate device in communication with interchange network 28 such that rules engine computing device 112 receives signals, including transaction data, from interchange network 28.

FIG. 2 is an expanded block diagram of an example embodiment of a rules engine platform 100 used in processing payment transactions that includes rules engine computing device 112 in accordance with one example embodiment of the present disclosure. In the example embodiment, platform 100 is used for tracking refund-eligible transactions and refunding conditional consumption taxes for a consumer, who is also a cardholder, as described herein.

More specifically, in the example embodiment, platform 100 includes a rules engine computing device 112, and a plurality of client sub-systems connected to rules engine computing device 112. Client sub-systems include merchant system 118 (also referred to as merchant computing device 118), registration system 120 (also referred to as registration computing device 120), and a user system 124 (also referred to as user computing device 124). In one embodiment, client sub-systems 118, 120, 124 are computers including a web browser, such that rules engine computing device 112 is accessible to client sub-systems 118, 120, 124 using the Internet and/or using network 115. Client sub-systems 118, 120, 124 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Merchant system 118 includes systems associated with merchants 24 (shown in FIG. 1) as well as external systems used to store data. For example, merchant system 118 may be a POS device communicatively couple to an external system of merchants 24. Registration system 120 includes systems associated with issuer banks 30 and/or refund agents 34 (shown in FIG. 1) as well as external systems used to store data. User system 124 includes systems associated with cardholders 22 (shown in FIG. 1) as well as external systems used to store data. Rules engine computing device 112 is also in communication with a payment network server 116 (also referred to as a payment network server 116) associated with interchange network 28 using network 115. Further, client sub-systems 118, 120, 124 may additionally communicate with interchange using network 115. Client sub-systems 118, 120, 124 could be any device capable of interconnecting to the Internet including a web-based phone, PDA, or other web-based connectable equipment.

A database server 114 is connected to database 130, which contains information on a variety of matters, as described below in greater detail. In one embodiment, centralized database 130 is stored on rules engine computing device 112 and can be accessed by potential users at one of client sub-systems 118, 120, 124 by logging onto rules engine computing device 112 through one of client sub-systems 118, 120, 124. Access to centralized database 130 is controlled by rules engine computing device 112 to limit the display of data to authorized users enrolled with rules engine computing device 112. In an alternative embodiment, database 130 is stored remotely from rules engine computing device 112 and may be non-centralized. Database 130 may be a database configured to store information used by rules engine computing device 112 including, for example, transaction data, conditional consumption tax rules, user data, merchant identifiers, merchant category codes, merchant locations, transaction amounts, product information (including, but not limited to, price and product category for products available for purchase), determined travel dates and specific travel date ranges for cardholders, analytics information, a database of user login information, and/or other data.

Database 130 may include a single database having separated sections or partitions, or may include multiple databases, each being separate from each other. In some embodiments, database 130 stores transaction data generated over the processing network including data relating to merchants, consumers, account holders, prospective customers, issuers, acquirers, and/or purchases made. In some further embodiments, database 130 stores transaction data generated over a payment processing network server different from payment network server 116. In additional embodiments, database 130 also stores account data including at least one of a cardholder name, a cardholder address, one or more primary account numbers (PANs), other account identifiers, and transaction information. Database 130 may also store merchant information including a merchant identifier that identifies each merchant registered to use the network, and instructions for settling transactions including merchant bank account information. Database 130 may also store purchase data associated with items being purchased by a cardholder from a merchant, and authorization request data.

In the example embodiment, registration system 120 includes a user interface 122, and user system 124 includes a user interface 128. User interfaces 122, 128 may include a graphical user interface with interactive functionality, such that cardholders 24 may enroll in a transaction monitoring service supported by rules engine computing device 112 through user interface 122 of registration system 120, and such that refund-eligible transactions, forms, and/or analytics, transmitted from rules engine computing device 112 to user system 124, may be shown in a graphical format. A user of registration system 120 may interact with user interface 122 to view, explore, edit, and otherwise interact with their enrollment data. A user of user system 124 may interact with user interface 128 to view, explore, print, send, and/or otherwise interact with identified and/or predicted products, refund-eligible transactions, generated consumption tax refund forms, and/or analytics. Rules engine computing device 112 may be supported by interchange network 28 and/or may process transaction data. Client systems 114 may be associated with a user who enrolls in the transaction monitoring service associated with rules engine computing device 112.

User interface 128 is also used, for example, to receive notifications from rules engine computing device 112 and/or to confirm/correct identified and/or predicted, by rules engine computing device 112, purchased products. In some embodiments, user system 124 may include an application 126. Application 126 may be, for example, a program or application that runs on user system 124.

In some embodiments, registration system 120 further includes an enrollment component for enrolling users with rules engine computing device 112. Enrollment data (e.g., initial username, initial password, cardholder information, proof of cardholder residency etc.) is transmitted by registration system 120 to rules engine computing device 112. For example, a user may access a webpage hosted by registration system 120 and access an application running on user system 124 to generate enrollment login information (e.g., username and password) and transmit the enrollment information to rules engine computing device 112. Application 126 stores the received login information data in a database of login information (e.g., in database 130). In some embodiments, application 126 may display a log-in page for receiving initial login information. Application 122 compares the candidate login information to the database of login information and determines if the candidate login information (e.g., username and password) matches the login information data stored in the database of login information.

In alternative embodiments, application 126 is accessed remotely by user system 124. Application 126 may be hosted by or stored on rules engine computing device 112 and accessed by user system 124. For example, TT application 124 may be stored on and executed by rules engine computing device 112. User system 124 may provide inputs to rules engine computing device 112 via network 115 which are used by rules engine computing device 112 to execute application 126. In one embodiment, these inputs may be received by a website hosted by rules engine computing device 112. The website may further provide output to user system 124. The user system 124 used by the user has access to a website (e.g., hosted by rules engine computing device 112), application (e.g., TT application 126), or other tool which the user uses to view refund-eligible transactions, generated consumption tax refund forms, and/or analytics provided by rules engine computing device 112 to the user.

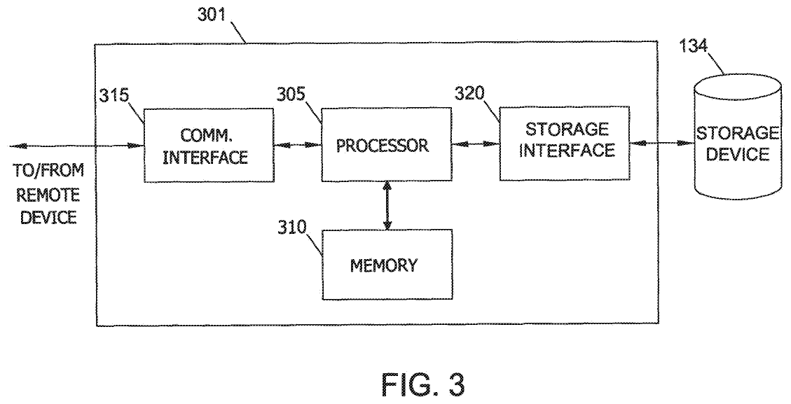

FIG. 3 illustrates an example configuration of a server (host computing device) system 301 such as rules engine computing device 112 (shown in FIG. 2) used to receive transaction data, determine merchant locations, identify and/or predict products purchased in the transaction, identify refund-eligible transactions, and to present the data on an interactive user interface, in accordance with one example embodiment of the present disclosure.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests (e.g., requests to display analytics and/or provide an interactive user interface) from a client system 114 via the Internet, as illustrated in FIG. 2.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system. In some embodiments, server system 301 also includes database server 116.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

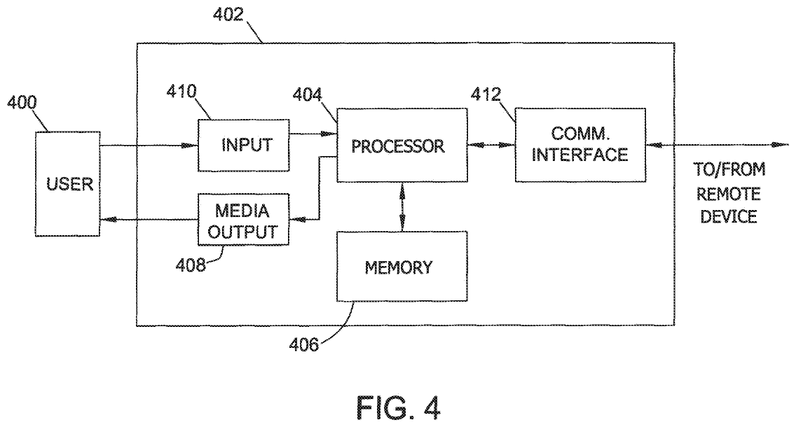

FIG. 4 illustrates an example configuration of a client computing device 402. Client computing device 402 may include, but is not limited to, merchant systems/computing devices 118, registration systems/computing devices 120, and client systems/computing devices 124. Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400 (e.g., a cardholder 22). Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 302 or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 406 are, for example, computer-readable instructions for providing a user interface to user 400 via media output component 408 and, optionally, receiving and processing input from input device 410. A user interface may include, among other possibilities, a web browser and client application. Web browsers enable users 400 to display and interact with media and other information typically embedded on a web page or a website from a web server associated with a merchant. A client application allows users 400 to interact with a server application associated with, for example, a merchant. The user interface, via one or both of a web browser and a client application, facilitates display of refund-eligible transactions by Rules engine computing device 112. The user may interact with the user interface to view and explore the transactions, for example, by selecting to view historic refund-eligible transactions using input device 410 and viewing analytics associated with same.

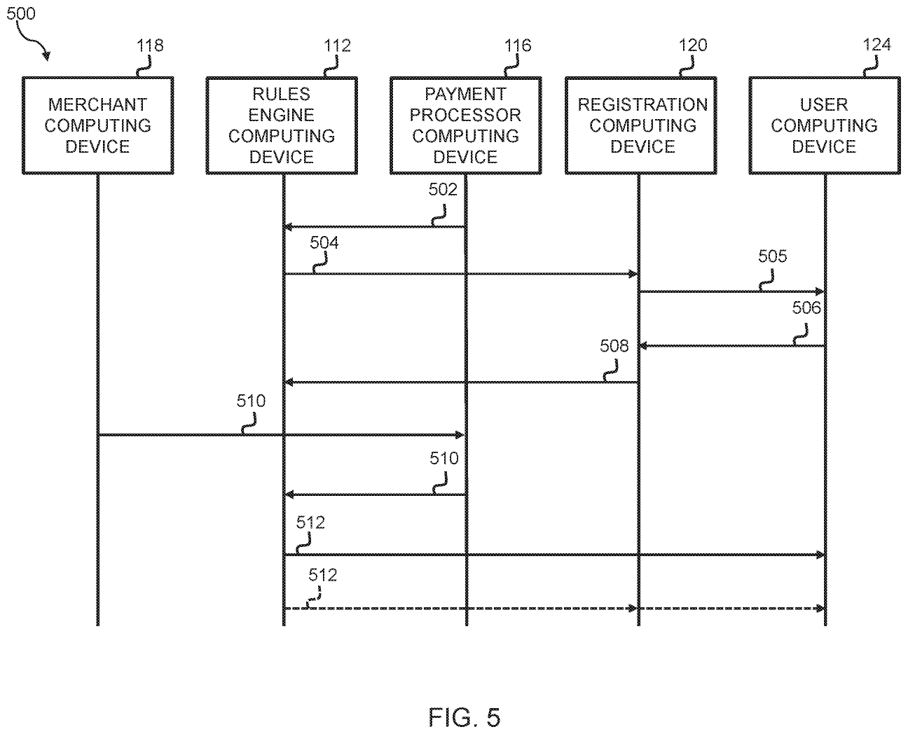

FIG. 5 is a data flow diagram 500 illustrating an example flow of data within the platform 100 of FIG. 2 including monitoring transactions for a consumer using transaction/purchase data.

Rules engine computing device 112 receives transaction data 502 associated with a plurality of cardholders 24 (shown in FIG. 1) from payment processor computing device 116. Rules engine computing device monitors the received transaction data 502 and determines candidate cardholders for a transaction monitoring service. Candidate cardholders for the transaction monitoring service are cardholders 24 who make purchases that suggest travel to, or presence in, countries and/or jurisdictions that apply conditional consumption taxes for which the cardholder, according to their home country, may be eligible for a refund of such tax. Rules engine computing device 112 generates and transmits a list 504 of candidate cardholders to registration computing device 120 (e.g., associated with issuer 30 or refund agent 34 shown in FIG. 1). Registration computing device 120 then prompts the candidate cardholder, e.g., via a prompt message 505 to user computing device 124, to enroll in the transaction monitoring service. In response to prompt message 505, the candidate cardholder enters enrollment information 506 (e.g., cardholder information, proof of residency, and/or travel itineraries) in user computing device 124, and enrollment information 506 is transmitted to registration computing device 120. Registration computing device 120 associates received enrollment information 506 from the candidate cardholder with a payment account number (PAN) of at least one payment account associated with the candidate cardholder. A message 508 including enrollment information and PAN of the candidate cardholder are then transmitted to rules engine computing device 112. From the received enrollment information and PAN of the candidate cardholder, rules engine computing device 112 associates the received enrollment information and PAN of the cardholder with the transaction monitoring service and begins monitoring received transaction data associated with the enrollment information and PAN. In some embodiments, the candidate cardholder may also enter one or more separate PANs associated with the candidate cardholder in enrollment information 506 such that the separate PANs may be associated with the candidate cardholder by rules engine computing device 112. In other embodiments, rules engine computing device 112 may automatically link all PANs associated with the candidate cardholder through querying databases (e.g., databases associated with other payment processor computing devices and/or other issuer computing devices) of PANs associated with the candidate cardholder based on enrollment information 506. In these embodiments, rules engine computing device 112 may then monitor received transaction data associated with all of the PANs and enrollment information of the candidate cardholder.

In response to a subsequent transaction by the cardholder, merchant computing device 118 transmits transaction data 510 (e.g., a merchant identifier, PAN, transaction amount, and merchant category code (MCC)) to payment processor computing device 116. Payment processor computing device 116 uses the merchant identifier and/or other data elements contained in the transaction data to identify a merchant location, and transmits transaction data 510 and merchant location to rules engine computing device 112 so that rules engine computing device 112 can parse received transaction data 510 to determine whether the transaction is refund-eligible. The transactions are determined to be refund-eligible by rules engine computing device 112 if the transactions follow conditional consumption tax rules stored by rules engine computing device 112, as described above in further detail.

Rules engine computing device 112 generates a list 512 of refund-eligible transactions and transmits the list 512 (along with any generated consumption tax refund forms, notifications, prompts, and/or analytics) to user computing device 124. Alternatively, rules engine computing device 112 transmits the list 512 to registration computing device 120, which may communicate the list 512 to user computing device 124. In some embodiments, registration computing device 120 may aggregate list 512 with other purchases (e.g., cash purchases) made by the cardholder such that registration computing device 120 may accurately track all of the purchase transactions of the cardholder. In embodiments where rules engine computing device 112 also retrieves transaction data from other sources (e.g., other payment processor computing devices or other issuer computing devices), rules engine computing device 112 aggregates refund-eligible transactions from the other sources into list 512.

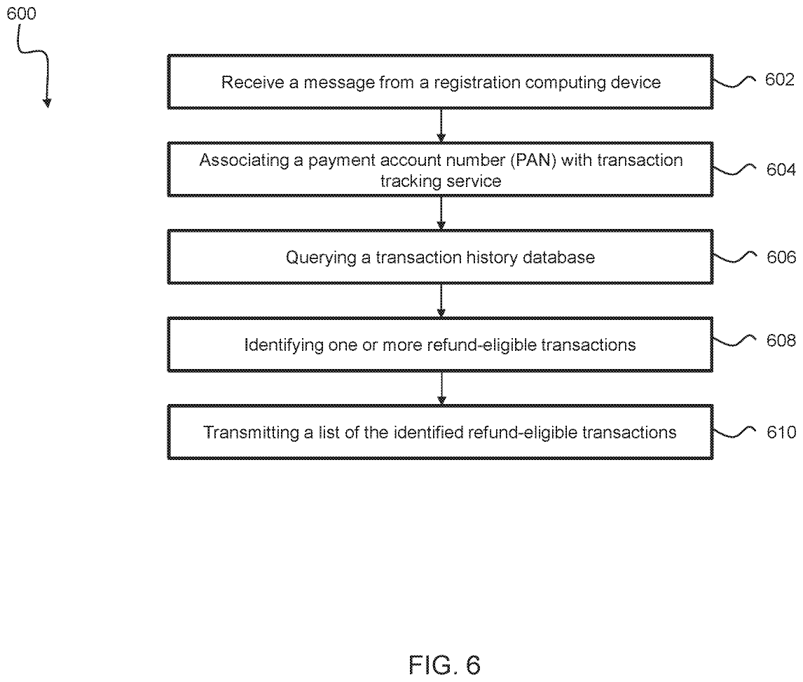

FIG. 6 illustrates a flow chart of an exemplary method 600 for monitoring message content (e.g., transaction data) for a cardholder. Method 600 may be carried out by rules engine computer device 112 (shown in FIG. 2).

In the example embodiment, method 600 includes receiving 602 a message from a registration computing device, such as an issuer or refund agent, that a cardholder (e.g., cardholder 24 shown in FIG. 1) is enrolled in a transaction monitoring service. The received 602 message includes information identifying at least one payment account number (PAN) of the cardholder. After the message is received 602, the method 600 includes associating 604 the PAN with the transaction monitoring service. The method further includes querying 606 a transaction history database to retrieve records (e.g., payment transactions) related to the PAN associated 604 with the transaction monitoring service. In the example embodiment, method 600 further includes identifying 608, based upon rules, a subset of transactions (e.g., one or more refund-eligible transactions). The one or more refund-eligible transactions are the payment transactions that are eligible for at least a partial refund of conditional consumption taxes. Method 600 further includes transmitting 610 a list of the identified 608 sub-set of transactions (e.g., the refund-eligible transactions) to at least one of the cardholder and the registration computing device.

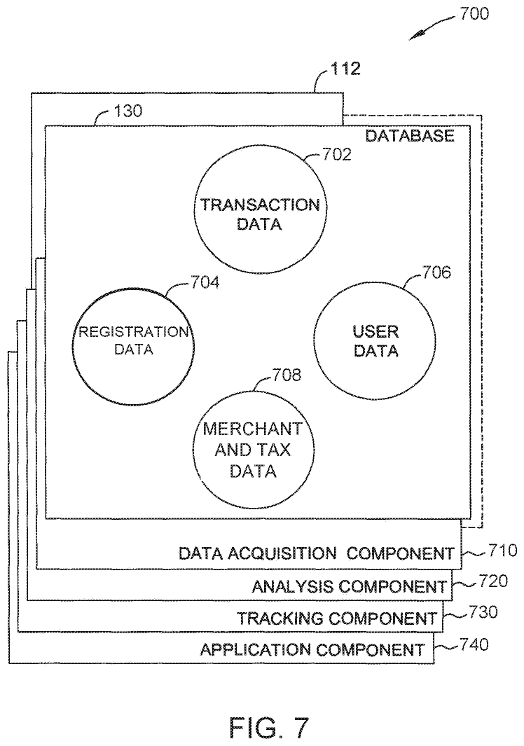

FIG. 7 is a diagram of components 700 of one or more example computing devices that may be used in the environment shown in FIG. 2. Rules engine computing device 112 includes database 130, a data acquisition component 710, an analysis component 720, a tracking component 730, and an application component 740. Database 130 may store information such as, for example, transaction data 702, registration data 704, user data 706 (e.g., cardholder information, login information, and enrollment information), merchant and tax data 708 (e.g., rules relating to merchants and taxes), and/or other data. Transaction data 702 is data related to transactions processed by one or more payment processing networks. Registration data 704 is data stored by one or more issuers or refund agents associated with one or more users. Database 130 is coupled to several separate components within rules engine computing device 112, which perform specific tasks.

Data acquisition component 710 receives a plurality of transaction signals for transactions from one or more payment processing networks and selects a candidate signal, as described above. The transaction data associated with the selected candidate signals is associated with a plurality of merchants. Analysis component 720 is used to determine refund-eligible transactions. That is, analysis component 720 determines products purchased by the cardholder from the transaction data and determines whether the transactions are refund-eligible. Tracking component 730 tracks the refund-eligible purchases and determines if transaction amounts of the tracked purchases reach a predetermined threshold amount. Application component 740 supports TT application 126 (shown in FIG. 2) and provides the cardholder with all of the generated information from rules engine computing device 112.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 305, 404, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

The above-described systems and methods enable allocating a minimum percentage of peak bandwidth to a priority class. More specifically, the systems and methods described herein provide determine peak bandwidth demand and allocate a minimum percentage of the peak bandwidth demand to a priority class.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for monitoring message content processed over a payment processor for a cardholder using a rules engine computing device, the rules engine computing device including a database of rules associated with refund-eligible transactions, the rules engine computing device being associated with the payment processor that maintains a transaction history database, the transaction history database including records for a plurality of payment transactions, each of the records including a payment account number (PAN), a merchant identifier, and a transaction amount, said method comprising:
receiving a message from a registration computing device indicating that the cardholder is enrolled in a transaction monitoring service, the message including information identifying at least one PAN of the cardholder;
associating the at least one PAN with the transaction monitoring service;
querying the transaction history database to retrieve records including the at least one PAN;
identifying, based on the rules, a subset of transactions from the retrieved records, wherein the subset of transactions are the payment transactions that are at least partially refund-eligible; and
transmitting a list of the identified subset of transactions to at least one of the cardholder and the registration computing device.

2. The method of claim 1 further comprising:
querying a second database to retrieve records associated with the cardholder, wherein the second database includes records separate from the records of the transaction history database;
identifying one or more refund-eligible transactions from the retrieved records of the second database; and
aggregating the identified one or more refund-eligible transactions from the retrieved records of the second database in the list of identified one or more refund-eligible transactions from the retrieved records of the transaction history database.

3. The method of claim 1 further comprising storing, in the memory, a plurality of jurisdictions in which conditional consumption taxes are charged, wherein identifying the one or more refund-eligible transactions further comprises, for each retrieved record:
identifying a location of the payment transactions based on the merchant identifier;
determining that the identified location is within one of the stored plurality of jurisdictions;
determining that a home country of the cardholder is outside the one of the stored plurality of jurisdictions;
determining whether the payment transaction amount is above a threshold, wherein the threshold is based on the one of the jurisdictions that includes the location of the transaction; and
determining whether the payment transaction is eligible for at least a partial refund of the conditional consumption taxes based on the determined threshold.

4. The method of claim 3, wherein each of the records further includes one of a plurality of merchant category codes, wherein the method further comprises associating, for each of the plurality of jurisdictions, a subset of the merchant category codes with non-refund-eligible transaction types, and wherein identifying the one or more refund-eligible transactions further comprises, for each record:
comparing the one of the merchant category codes in the record to the subset corresponding to the one of the jurisdictions; and
in response to determining that the one of the merchant category codes is in the subset, excluding the corresponding transaction from the identified one or more transactions.

5. The method of claim 3 further comprising:
monitoring at least one stream of transaction data of a plurality of cardholders, each cardholder having a home country outside of the one of the plurality of jurisdictions, the stream of transaction data processed over the payment processor;
identifying candidate cardholders for the transaction monitoring service by detecting indicators in the at least one stream of transactions within the one of the plurality of jurisdictions; and
transmitting a list of the identified candidate cardholders to the registration computing device.

6. The method of claim 3 further comprising:
determining a date on which the cardholder is expected to exit the one of the plurality of jurisdictions based on at least one of (i) the received message from the issuer and (ii) at least one record of the cardholder in the transaction history database; and
transmitting a refund reminder message to the cardholder within 48 hours of the determined date.

7. The method of claim 1 further comprising:
generating a consumption tax refund form for at least one of the identified transactions of the cardholder, wherein the consumption tax refund form is submittable by the cardholder to obtain at least a partial refund of conditional consumption taxes for the identified subset of transactions.

8. A rules engine computing device for monitoring message content processed over a payment processor for a cardholder, said rules engine computing device including a database of rules associated with refund-eligible transactions, said rules engine computing device being associated with the payment processor that maintains a transaction history database, the transaction history database including records for a plurality of payment transactions, each of the records including a payment account number (PAN), a merchant identifier, and a transaction amount, said rules engine computing device comprising one or more processors in communication with one or more memory devices, said rules engine computing device configured to:
receive a message from a registration computing device indicating that the cardholder is enrolled in a transaction monitoring service, the message including information identifying at least one PAN of the cardholder;
associate the at least one PAN with the transaction monitoring service;
query the transaction history database to retrieve records including the at least one PAN;
identify, based on the rules, a subset of transactions from the retrieved records, wherein the subset of transactions are the payment transactions that are at least partially refund-eligible; and
transmit a list of the identified subset of transactions to at least one of the cardholder and the registration computing device.

9. The rules engine computing device of claim 8, said rules engine computing device further configured to:
query a second database to retrieve records associated with the cardholder, wherein the second database includes records separate from the records of the transaction history database;
identify one or more refund-eligible transactions from the retrieved records of the second database; and
aggregate the identified one or more refund-eligible transactions from the retrieved records of the second database in the list of identified one or more refund-eligible transactions from the retrieved records of the transaction history database.

10. The rules engine computing device of claim 8, further configured to store, in the memory, a plurality of jurisdictions in which conditional consumption taxes are charged, said rules engine computing device further configured to:
identify a location of the transaction based on the merchant identifier;
determine that the identified location is within one of the stored plurality of jurisdictions;
determine that a home country of the cardholder is outside the one of the stored plurality of jurisdictions;
determine whether the transaction amount is above a threshold, wherein the threshold is based on the one of the jurisdictions that includes the location of the transaction; and
determine whether the transaction is eligible for at least a partial refund of the conditional consumption taxes based on the determined threshold.

11. The rules engine computing device of claim 10, wherein each of the records further includes one of a plurality of merchant category codes, wherein said rules engine computing device is further configured to associate, for each of the plurality of jurisdictions, a subset of the merchant category codes with non-refund-eligible transaction types, and wherein said rules engine computing device, for each record, is further configured to:
compare the one of the merchant category codes in the record to the subset corresponding to the one of the jurisdictions; and
in response to determining that the one of the merchant category codes is in the subset, exclude the corresponding transaction from the identified one or more transactions.

12. The rules engine computing device of claim 10, said rules engine computing device further configured to:
monitor at least one stream of transaction data of a plurality of cardholders, each cardholder having a home country outside of the one of the plurality of jurisdictions, the stream of transaction data processed over the payment processor;
identify candidate cardholders for the transaction monitoring service by detecting indicators in the at least one stream of transactions within the one of the plurality of jurisdictions; and
transmit a list of the identified candidate cardholders to respective issuers of the payment account numbers (PANs) of the cardholders.

13. The rules engine computing device of claim 10, said rules engine computing device further configured to:
determine a date on which the cardholder is expected to exit the one of the plurality of jurisdictions based on at least one of (i) the received message from the issuer and (ii) at least one record of the cardholder in the transaction history database; and
transmit a refund reminder message to the cardholder within 48 hours of the determined date.

14. The rules engine computing device of claim 8, said rules engine computing device further configured to:
generate a consumption tax refund form for at least one of the identified transactions of the cardholder, wherein the consumption tax refund form is submittable by the cardholder to obtain at least a partial refund of conditional consumption taxes for the at least one identified transaction.

15. At least one non-transitory computer-readable media having computer-executable instructions thereon for monitoring message content processed over a payment processor for a cardholder using a rules engine computing device, the rules engine computing device including a database of rules associated with refund-eligible transactions and being associated with the payment processor that maintains a transaction history database, the transaction history database including records for a plurality of payment transactions, each of the records including a payment account number (PAN), a merchant identifier, and a transaction amount, wherein the computer executable instructions, when executed by at least one processor of the rules engine computing device, cause the at least one processor to:
receive a message from a registration computing device indicating that the cardholder is enrolled in a transaction monitoring service, the message including information identifying at least one PAN of the cardholder;
associate the at least one PAN with the transaction monitoring service;
query the transaction history database to retrieve records including the at least one PAN;
identify, based on the rules, a subset of transactions from the retrieved records, wherein the subset of transactions are the payment transactions that are at least partially refund-eligible; and
transmit a list of the identified subset of transactions to at least one of the cardholder and the registration computing device.

16. The computer-readable media of claim 15 further causing the at least one processor to:
query a second database to retrieve records associated with the cardholder, wherein the second database includes records separate from the records of the transaction history database;
identify one or more refund-eligible transactions from the retrieved records of the second database; and
aggregate the identified one or more refund-eligible transactions from the retrieved records of the second database in the list of identified one or more refund-eligible transactions from the retrieved records of the transaction history database.

17. The computer-readable media of claim 15 further causing the at least one processor to store, in the memory, a plurality of jurisdictions in which conditional consumption taxes are charged, and further causing that least one processor to:
identify a location of the payment transactions based on the merchant identifier;
determine that the identified location is within one of the stored plurality of jurisdictions;
determine that a home country of the cardholder is outside the one of the stored plurality of jurisdictions;
determine whether the payment transaction amount is above a threshold, wherein the threshold is based on the one of the jurisdictions that includes the location of the transaction; and
determine whether the payment transaction is eligible for at least a partial refund of the conditional consumption taxes based on the determined threshold.

18. The computer-readable media of claim 17, wherein each of the records further includes one of a plurality of merchant category codes, further causing the at least one processor to associate, for each of the plurality of jurisdictions, a subset of the merchant category codes with non-refund-eligible transaction types, and further causing the at least one processor to:
compare the one of the merchant category codes in the record to the subset corresponding to the one of the jurisdictions; and
in response to determining that the one of the merchant category codes is in the subset, exclude the corresponding transaction from the identified one or more transactions.

19. The computer-readable media of claim 17 further causing the at least one processor to:
monitor at least one stream of transaction data of a plurality of cardholders, each cardholder having a home country outside of the one of the plurality of jurisdictions, the stream of transaction data processed over the payment processor;
identify candidate cardholders for the transaction monitoring service by detecting indicators in the at least one stream of transactions within the one of the plurality of jurisdictions; and
transmit a list of the identified candidate cardholders to the registration computing device.

20. The computer-readable media of claim 17 further causing the at least one processor to:
determine a date on which the cardholder is expected to exit the one of the plurality of jurisdictions based on at least one of (i) the received message from the issuer and (ii) at least one record of the cardholder in the transaction history database; and
transmit a refund reminder message to the cardholder within 48 hours of the determined date.

21. The computer-readable media of claim 15 further causing the at least one processor to:
generate a consumption tax refund form for at least one of the identified transactions of the cardholder, wherein the consumption tax refund form is submittable by the cardholder to obtain at least a partial refund of conditional consumption taxes for the identified subset of transactions.
